(19) United States
(12) Patent Application Publication
(10) Pub. No.: US 2006/0134391 A1
(43) Pub. Date: Jun. 22, 2006

(54) Methods for making arts and crafts articles and merchandised articles relating thereto

(75) Inventor: Peter D. Spohn, Brookline, NY (US)

Correspondence Address: LARSON NEWMAN ABEL POLANSKY & WHITE, LLPL., 5914 WEST COURTYARD DRIVE, SUITE 200, AUSTIN, TX, 78746, US

(73) Assignee: SAINT-GOBAIN PERFORMANCE PLASTICS CORPORATION

(21) Appl. No.: 11/016,343

(22) Filed: Dec. 17, 2004

(51) Int. Cl. B41M 5/00

(52) U.S. Cl. 428/195.1

(57) ABSTRACT

The disclosure is directed to a method for making a craft article. The method includes placing a craft mat on a work surface. The craft mat has a first major surface formed of silicone elastomer and has a second major surface formed of fluorinated polymer. The method further includes placing a material on the craft mat and forming the craft article on the craft mat from the material.

### FIELD OF THE DISCLOSURE

This disclosure, in general, relates to methods for making or forming arts and crafts articles.

### BACKGROUND

Arts and crafts activities are frequently engaged in by children for entertainment and education, as well as by adults to relieve stress or produce supplemental income. However, arts and crafts related activities frequently involve use of adhesives, paints, and other materials that are difficult to clean from work surfaces and often ruin those work surfaces. In particular, many parents complain of ruined furniture caused by child crafts.

Oftentimes, hobbyists and parents have turned to newspaper to cover work surfaces in an effort to limit damage or make clean up easier. However, newspaper tends to allow substances, such as glue and paint, to bleed through onto the working surfaces. In addition, the ink from the newspaper may undesirably transfer onto hands and craftwork. Moreover, newspaper may become attached to, or stuck on a craft article, ruining the craft article.

Ruined craft articles and work surfaces often lead to distraught adults and tearful children. As such, improved methods for making craft articles would be desirable.

### SUMMARY

In a particular embodiment, the disclosure is directed to a method for making a craft article. The method includes placing a craft mat on a work surface. The craft mat has a first major surface formed of silicone elastomer and has a second major surface formed of fluorinated polymer. The method further includes placing a material on the craft mat and forming the craft article on the craft mat from the material.

In another embodiment, the disclosure is directed to a merchandised article including a craft mat having a first major surface formed of silicone elastomer and having a second major surface formed of fluorinated polymer. The merchandised article also includes packaging coupled to the craft mat. The packaging provides a sales message associated with the craft mat. The merchandised article further includes printed instructions included with the packaging. The printed instructions direct a user to place the craft mat on a work surface prior to forming a craft article.

In a further embodiment, the disclosure is directed to a method of making a craft article. The method includes placing a craft mat on a working surface. The craft mat has a first major surface formed of elastomeric material having a high coefficient of friction. The craft mat also has a second major surface formed of polymeric material having a low coefficient of friction. The method further includes placing a material on the craft mat and forming the craft article on the craft mat from the material.

### BRIEF DESCRIPTION OF THE DRAWINGS

The present disclosure may be better understood, and its numerous features and advantages made apparent to those skilled in the art by referencing the accompanying drawings.

FIG. 1 includes a diagram illustrating an exemplary craft system.

FIGS. 2 and 3 include diagrams illustrating exemplary craft mats.

FIG. 4 includes a diagram illustrating an exemplary merchandised article associated with craft mats.

FIG. 5 includes a flow diagram illustrating an exemplary method for making craft articles.

The use of the same reference symbols in different drawings indicates similar or identical items.

### DETAILED DESCRIPTION OF THE DRAWINGS

In one particular embodiment, the disclosure is directed to a method of making a craft article. The method includes placing a craft mat on a work surface and forming or making the craft article on the craft mat from a material placed thereon. The craft mat includes a first major surface formed of high coefficient of friction material, such as silicone elastomer. The craft mat also includes a second major surface formed of low coefficient of friction material, such as fluorinated polymer, such as PTFE. In one exemplary embodiment, the first major surface has a higher coefficient of friction than the second major surface. The first major surface may be placed face down on a work surface and the craft article may be formed on or over the second major surface.

In another exemplary embodiment, the disclosure is directed to a merchandised article including a craft mat and packaging. The packaging may be coupled to the craft mat and may include a sales identification associated with the craft mat. In addition, the merchandising article may include printed instructions directing the placement of the craft mat on a work surface and the formation or making of a craft article on the craft mat. In one exemplary embodiment, the instructions may include directions to place a first major surface, such as a silicone elastomeric surface, face down on the work surface and to form the craft article on a second major surface formed of fluorinated polymer.

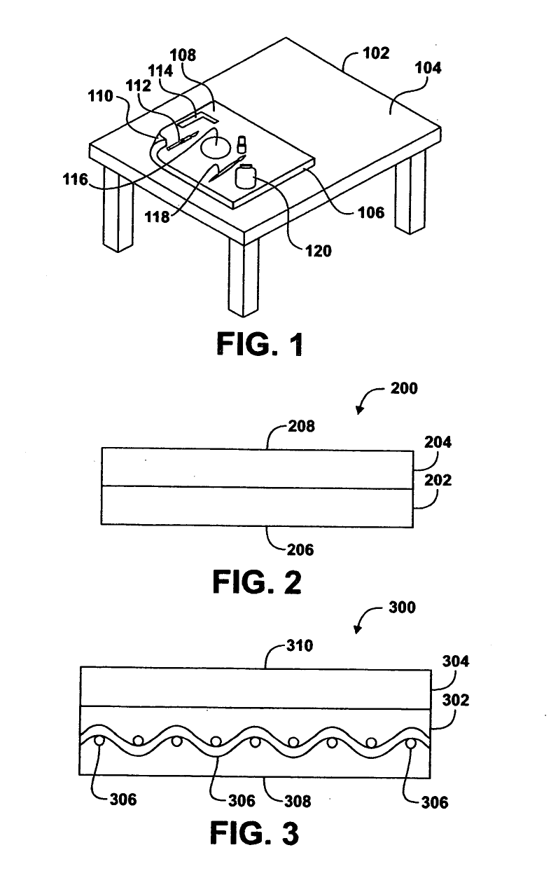

FIG. 1 illustrates an exemplary embodiment in which a table 102 has a working surface 104. A craft mat 106 is placed over the working surface 104. The craft mat includes a first major surface 110 formed of high coefficient of friction material, such as silicone elastomer. The craft mat also includes a second major surface 108 formed of lower coefficient of friction material, such as fluorinated polymer. Generally, the high coefficient of friction surface 110 is placed face down on the work surface and craft articles are formed on the low coefficient of friction surface 108.

Forming the craft article may include various activities, such as assembling parts, shaping clay, coloring, painting, or gluing, each of which involves manipulation of material on the craft mat. As such, any one craft making activity may include one or more items or materials, such as markers 112, article pieces 114, clay 116, paints 118, and glue 120. These items or materials may damage work surfaces if allowed to reside on the work surfaces without protection. For example, paint may permanently discolor a working surface and glue may interact with surface finishings of a work surface. Parts 114 may scratch a work surface, and Play-Dough or clays 116 may infiltrate surface cracks on a working surface and be difficult to clean or remove.

In one exemplary embodiment, the craft mat is formed of at least two layers. FIGS. 2 and 3 illustrate exemplary craft mats. For example, FIG. 2 illustrates a two-layer craft mat 200, in which layers 202 and 204 form opposite major surfaces 206 and 208 respectively.

Layer 202 includes a low surface energy material, such as a non-stick material. In one particular embodiment, the material has a low coefficient of friction. For example, layer 202 may include fluorinated polymer. The fluorinated polymer can be a homopolymer of fluorine-substituted monomers or a copolymer including at least one fluorine-substituted monomer. Exemplary fluorine substituted monomers include tetrafluoroethylene (TFE), vinylidene fluoride (VF2), hexafluoropropylene (HFP), chlorotrifluoroethylene (CTFE), perfluoroethylvinyl ether (PEVE), perfluoromethylvinyl ether (PMVE), and perfluoropropylvinyl ether (PPVE). Examples of fluorinated polymers include polytetrafluoroethylene (PTFE), perfluoroalkylvinyl ether (PFA), fluorinated ethylene-propylene copolymer (FEP), ethylene tetrafluoroethylene copolymer (ETFE), polyvinylidene fluoride (PVDF), polychlorotrifluoroethylene (PCTFE), and TFE copolymers with VF2 and/or HFP. In one particular embodiment, layer 202 includes PTFE.

While layer 202 is illustrated as a single layer, layer 202 may be formed of several layers of one or more fluorpolymers. For example, layer 202 may be formed through coating several layers of fluoropolymer and sintering after each coating or after the final coat is applied.

Layer 204 includes high coefficient of friction material. For example, layer 204 may include elastomeric material. Exemplary materials include polyorganosiloxane, polyolefins, polyurethane, ethylene propylene diene monomer (EPDM) polymers, and mixtures thereof. In one exemplary embodiment, the high coefficient of friction material is substantially free of fluorination. In one particular embodiment, the high coefficient material also has low surface energy and may, for example, be non-stick material. For example, layer 204 may include polyorganosiloxane, such as silicone elastomer.

Other components may be present in the materials used to form layers 202 and 204. For example, the layers can include fillers, light stabilizers, pigments, and bonding aids. Exemplary fillers include talc, silica, and calcium carbonate. Exemplary light absorbing additives and pigments include TiO₂, Fe₂O₃, carbon black, and calcined mixed metal oxides.

In another exemplary embodiment, the craft mat may include reinforcement, such as fibrous reinforcement. FIG. 3 illustrates an exemplary craft mat 300 including reinforcement 306. Here, layer 302 may include low surface energy material and form a major surface 308. Layer 304 may include high coefficient of friction material and form a major surface 310. Layer 302 may include materials described above in relation to layer 202 of FIG. 2 and layer 304 may include materials described above in relation to layer 204 of FIG. 2. In one exemplary embodiment, the reinforcement material 306 is incorporated into layer 302. Alternatively, the reinforcement material 306 is incorporated into layer 304. In another exemplary embodiment, the reinforcement material 306 is located between layers 302 and 304.

The reinforcement material 306 may be formed of organic or inorganic materials. Exemplary inorganic materials include carbon fiber, metal filament, such as steel and copper wire, ceramic filaments, such as glass fiber, and blends thereof. Exemplary organic materials include natural fibers, such as cotton, wool, and blends thereof and polymeric materials, such as polyester, polyamide, polyaramid, polyamideimide, polyimide, polyolefin, and blends or copolymers thereof. In one exemplary embodiment, the reinforcement material 306 is incorporated into layer 302 and is formed from polyaramid materials, such as meta- or para-polyaramid materials. In another exemplary embodiment, the reinforcement material 306 is incorporated into layer 304 and is formed from polyester materials or polyamide material, such as nylon materials. Generally, the reinforcement material 306 is coated with one or both of the materials of layers 302 and 304, typically coated so as to be generally embedded in one of the layers 302 or 304. More particularly, the reinforcement material 306 may be coated with fluorinated polymer (e.g. embedded in layer 302) or may be (coated with silicone elastomer (e.g. embedded in layer 304).

The reinforcement material 306 includes woven fibers (e.g. stitched or in a weave) or non-woven fibers, (e.g. randomly distributed fibers). The craft mat may include one or more layers, sheets or types of reinforcement material.

In one particular embodiment, the craft mat is configured to withstand cooking and processing temperatures without charring, burning, or melting. For example, reinforcement materials, low coefficient of friction materials, and high coefficient of friction materials may be selected that withstand cooking temperatures at least about 350° F., such as at least about 450° F., at least about 500° F., or at least about 550° F. For example, clays and other crafts may be cooked or dried in an oven or kiln. In particular examples, reinforcement materials are selected to withstand processing (i.e. fabrication) temperatures of the other materials of the liner. For example, the reinforcement material may be selected to withstand processing temperatures at least about 500° F., such as at least about 600° F., at least about 650° F., or at least about 750° F. In one particular embodiment, a reinforcement material, such as polyaramid, is selected to withstand the processing temperatures of low surface energy, low coefficient of friction material, such as PTFE. One side of the reinforced PTFE may then be coated with high coefficient of friction material, such as silicone elastomer, in a process using lower processing temperatures.

In one exemplary embodiment, the craft mat is formed through a process of coating a carrier web and/or a reinforcement material with a low surface energy, low coefficient of friction material, such as fluorinated polymer. PTFE is one such fluorinated polymer. The carrier web and/or the reinforcement material are paid from a roll and coated on one side with a suspension including fluorinated polymer particles dispersed in a liquid medium. In one particular embodiment, the suspension includes Fluon® ADILN PTFE aqueous dispersion to which 0.5% Zonyl® FSO fluorosurfactant from DuPont has been added.

A blade or metering rods are positioned to remove excess suspension from the carrier web. The suspension is then dried and sintered to form a layer on the carrier web. In one particular embodiment, the coated suspension is dried at about 332° F. and sintered at about 649° F. The thickness of the layer may be increased by repeating the coating process. In one exemplary embodiment, the carrier web may be coated with the suspension, the suspension dried, and a second coating applied to the dried suspension before sintering.

An exposed surface of the fluorinated polymer is rendered bondable. For example, the surface may be chemically etched with an etching composition, such as sodium metal/naphthalene/glycol ether mixture and sodium metal/anhydrous ammonia mixture. In other exemplary embodiments, the surface is rendered bondable through electrochemical treatments, metal sputtering and deposition of metals and/or metal oxides. For example, deposition of metals and metal oxides may include chemical vapor deposition and physical vapor deposition.

In another exemplary embodiment, the surface of the fluorinated polymer is rendered bondable by impregnating the material with colloidal silica. For example, the fluorinated polymer may include 25-70 wt % colloidal silica. In a further example, the surface may be rendered bondable by applying to the surface a coating of FEP or PFA including colloidal silica. The FEP or PFA coating is dried and sintered or fused to the surface of the fluorinated polymer, such as PTFE. In one particular embodiment, the fluorinated polymer surface is coated with a mixture of DuPont FEP TE-9503, Ludox® LS 30 colloidal silica dispersion from W.R. Grace Company, and Triton® X-100 non-ionic surfactant.

Once the surface is bondable, a high coefficient of friction material, such as silicone elastomer, is applied to the bondable surface. For example, precursors of silicone elastomer may be coated on the bondable surface and cured. In one exemplary embodiment, a platinum catalyzed liquid silicone rubber solution is applied to the bondable surface of the fluorinated polymer layer. The coating may be heated to deactivate or evaporate inhibitors, allowing the liquid silicone rubber solution to cure. In another exemplary embodiment, an organic peroxide catalyzed silicone rubber is coated to the fluorinated polymer layer and the coating is heated to facilitate curing. Other exemplary silicone elastomers include moisture-curing silicones. In one particular embodiment, the silicone elastomer precursor coating includes 50 parts 9252-500P Part A and 50 parts 9252-500P Part B liquid silicone rubber from Dow Corning Corporation in which Part A includes a platinum catalyst and Part B includes a crosslinking agent and a cure inhibitor capable of being removed by heat. Multiple coatings of the silicone material may be applied, and reinforcement material may be incorporated in the silicone layer.

In exemplary embodiments, the thickness of the fluorinated polymer layer is generally about 0.2-12 mils. In one example, the thickness is about 4-12 mils. In another example the thickness is about 0.2-4 mils, such as about 0.5-4 mils. The silicone layer is generally about 2-100 mils. In one example, the thickness of the silicone layer is about 4-20 mils. Alternatively, the thickness of the silicone layer is about 2-10 mils, such as about 5-10 mils. For example, when a reinforcement material is embedded in the fluorinated polymer layer, the thickness of the fluorinated polymer layer may be about 4-12 mils and the thickness of the silicone layer may be about 2-10 mils. Alternatively, when the reinforcement material is embedded in the silicone layer, the thickness of the fluorinated polymer layer may be about 0.5-4 mils and the thickness of the silicone layer may be about 4-20 mils.

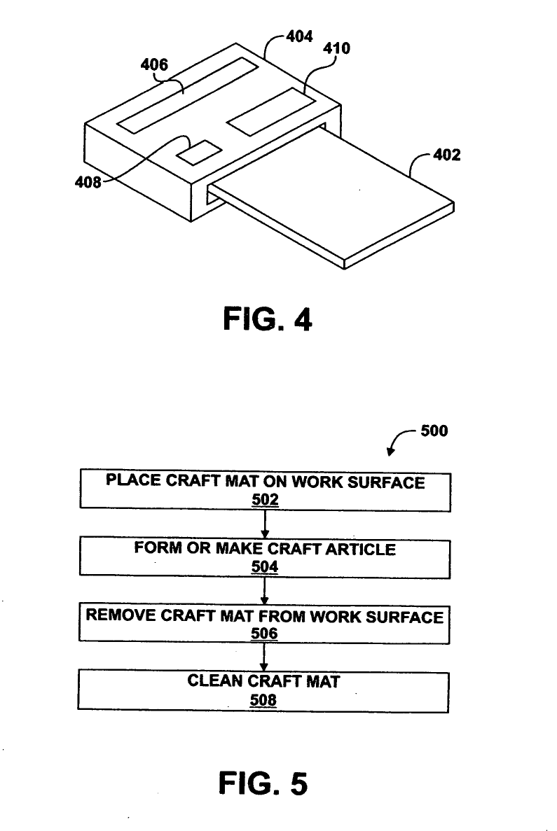

In one exemplary embodiment, the craft mat is included in a merchandised article for commercial sale. FIG. 4 illustrates a merchandised article including a craft mat 402 and packaging 404. The packaging 404 is connected to the craft mat 402. The packaging 404 may include a sales message, title or description of the craft mat 406 and a barcode 408 or other indicator of sales price or facilitator of a sales transaction.

In addition, the merchandised article may include a set of printed instructions 410. The printed instructions 410 may be printed on the packaging 404 or included as a separate sheet with the packaging 404 and craft mat 402. In one exemplary embodiment, the instructions direct a user to place the craft mat 402 on a work surface. In another exemplary embodiment, the instructions 410 direct a user to place a high coefficient of friction side of the craft mat face down on the work surface and form the craft articles on a low coefficient of friction side of the craft mat. In another exemplary embodiment, the instructions 410 suggest removing the craft mat from the work surface and cleaning the craft mat.

The craft mat may be used to protect working surfaces during the formation of a craft article. FIG. 5 illustrates an exemplary method 500 for making a craft article. A craft mat is placed on a work surface, as shown at 502. The craft mat includes a first major surface formed of higher coefficient of friction elastomer, such as a silicone elastomer. The craft mat also includes a second major surface formed of lower coefficient of friction material, such as fluorinated polymer. Both surfaces may be formed of low surface energy materials, such as materials that are easily cleaned, stain-resistant, and stick-resistant. In one particular embodiment, the first major surface including the high coefficient of friction material is placed face down on the working surface, and the craft articles are formed on the second major surface formed of the lower coefficient of friction material.

The craft articles may be formed or made on the craft mat, as shown at 504. Generally, formation of a craft article begins with placing a material or materials on the mat, from which the craft article is formed. Such materials include paper, paint, glue, wood, cardboard, and hardening and non-hardening clay, including modeling clay. Making or forming craft articles utilizing such materials may involve painting, such as finger painting or painting with a brush, or assembling parts, such as assembling parts with glue or adhesive. In a further exemplary embodiment, making or forming craft articles involves coloring with markers, crayons or pens. Making or forming of the craft article may also include modeling clay or manipulating Play-Dough.

Once work on the craft article is complete, the craft mat may be removed from the work surface, as shown at 506 and easily cleaned, as shown at 508. In one particular embodiment, the craft mat protects the working surface from damage potentially caused by adhesives, glues, paints, clays, Play-Dough, and markers. In another exemplary embodiment, the high coefficient of friction surface prevents the mat from moving about the work surface during craft article construction. In a further exemplary embodiment, the non-stick or low surface energy surface of the craft mat prevents sticking of the mat to the craft article.

In one particular embodiment, the multilayer craft mat and craft making methods incorporating same as described above are particularly advantageous. For example, the craft mat may provide a surface that prevents sticking of articles, while preventing sliding when placed on the work surface. In a further exemplary embodiment, the craft mat is easy to clean.

According to some aspects of the above embodiments, the multi-layered composite structure is less likely to slip across a work surface than PTFE sheets. In addition, the multi-layered composite structure is more damage resistant and easier to clean than silicone sheets.

Further details of the construction of the craft mat may be found in US Patent Application Publication No. US 2001/0034170A1 (US '170), incorporated herein by reference. It is noted that the US '170 is generally directed to composite structures utilized in the context of closed-loop belts, not in the context of craft mats and methods of making craft items incorporating same.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for making a craft article, the method comprising:
placing a craft mat on a work surface, the craft mat having a first major surface formed of silicone elastomer and having a second major surface formed of fluorinated polymer;
placing a material on the craft mat; and
forming the craft article on the craft mat from the material.

2. The method of claim 1, wherein the material includes craft article pieces, and wherein forming the craft article includes gluing the craft article pieces together.

3. The method of claim 1, wherein forming the craft article includes painting the material.

4. (canceled)

5. The method of claim 1, wherein forming the craft article includes coloring the material with a colored marker.

6. The method of claim 1, wherein the material includes a moldable mass, and wherein forming the craft article includes shaping the moldable mass

7. (canceled)

8. The method of claim 1, wherein placing the craft mat on the working surface includes placing the craft mat such that the first major surface substantially contacts the working surface.

9. The method of claim 1, wherein the craft mat includes fibrous reinforcement.

10. The method of claim 9, wherein the fibrous reinforcement is woven.

11. The method of claim 10, wherein the fibrous reinforcement comprises woven fiberglass and polyaramid yarns.

12. The method of claim 9, wherein the fibrous reinforcement is coated with the fluorinated polymer.

13. The method of claim 12, wherein the silicone elastomer is coupled to the fluorinated polymer.

14. The method of claim 9, wherein the fibrous reinforcement is coated with the silicone elastomer.

15. The method of claim 1, wherein the silicone elastomer has a higher coefficient of friction than the fluorinated polymer.

16. A merchandised article comprising:
a craft mat having a first major surface formed of silicone elastomer and having a second major surface formed of fluorinated polymer;
packaging coupled to the craft mat, the packaging providing a sales message associated with the craft mat; and
printed instructions included with the packaging, the printed instructions directing a user to place the craft mat on a work surface prior to forming a craft article.

17. The merchandised article of claim 16, wherein the printed instructions direct a user to place the craft mat such that the first major surface substantially contacts the work surface.

18. The merchandised article of claim 16, wherein the printed instructions direct the user to form the craft article on the craft mat.

19. The merchandised article of claim 16, wherein the craft mat includes reinforcement.

20. (canceled)

21. (canceled)

22. (canceled)

23. (canceled)

24. (canceled)

25. A method of making a craft article, the method comprising:
placing a craft mat on a working surface, the craft mat having a first major surface formed of elastomeric material having a high coefficient of friction, the craft mat having a second major surface formed of polymeric material having a low coefficient of friction;
placing a material on the craft mat; and
forming the craft article on the craft mat from the material.

26. The method of claim 25, wherein the elastomeric material includes silicone rubber.

27. The method of claim 25, wherein the polymeric material includes fluorinated polymer.

28. (canceled)

29. (canceled)

30. (canceled)
